(19) United States
(12) Patent Application Publication
(10) Pub. No.: US 2021/0023905 A1
(43) Pub. Date: Jan. 28, 2021

(54) DAMPER CONTROL SYSTEM, VEHICLE, INFORMATION PROCESSING APPARATUS AND CONTROL METHOD THEREOF, AND STORAGE MEDIUM

(71) Applicant: HONDA MOTOR CO., LTD., Tokyo (JP)

(72) Inventor: Gakuyo FUJIMOTO, Wako-shi (JP)

(21) Appl. No.: 16/928,390

(22) Filed: Jul. 14, 2020

(30) Foreign Application Priority Data
Jul. 22, 2019 (JP) 2019-134773

(51) Int. Cl. B60G 17/06; G06N 20/00

(52) U.S. Cl. CPC B60G 17/06; G06N 20/00

(57) ABSTRACT

A damper control system includes a damper control unit which controls a property of a damper used in a suspension of a vehicle; and a processing unit which accepts feedback data pertaining to behavior of the vehicle measured in the vehicle, applies computational processing specified by executing a machine learning algorithm to the feedback data, and outputs a control variable obtained from the computational processing to the damper control unit. The damper control unit controls the property of the damper on the basis of a control variable used internally within the damper control unit, and replaces the control variable used internally with a new control variable. The new control variable is the control variable output by the processing unit.

### CROSS-REFERENCE TO RELATED APPLICATION(S)

This application claims priority to and the benefit of Japanese Patent Application No. 2019-134773 filed on Jul. 22, 2019, the entire disclosure of which is incorporated herein by reference.

### BACKGROUND OF THE INVENTION

### Field of the Invention

The present invention relates to a damper control system, a vehicle, an information processing apparatus and a control method thereof, and a storage medium.

### Description of the Related Art

Techniques which use machine learning algorithms to adaptively control the autonomous travel of a vehicle (also called “automated driving”) are known. Japanese Patent Laid-Open No. 2018-37064 discloses a vehicle control technique based on reinforcement learning which does not carry out active searches.

Meanwhile, recent years have seen the appearance of vehicles employing active dampers, which are capable of controlling the damping forces of the dampers in the vehicle wheels, as dampers used in the suspension. By controlling the damping forces, the roll behavior and the like of the vehicle can be controlled, which in turn makes it possible to provide a more comfortable ride.

Incidentally, it is conceivable to employ machine learning algorithms to directly control the damping force of an active damper. When using a machine learning algorithm (i.e., a deep reinforcement learning algorithm) to directly control active dampers and improve the ride comfort, the response performance of the control using the algorithm becomes an issue. In other words, if an attempt is made to improve the ride comfort for a wide range of behaviors, there will be cases where the response performance of the damping force control itself must be improved to around several milliseconds. However, depending on the calculation load of the machine learning algorithm, improving the damping force control response performance to several milliseconds while ensuring robustness may not be realistic in terms of calculation resources.

### SUMMARY OF THE INVENTION

The present invention has been made in consideration of the aforementioned issues, and realizes a technique which makes it possible to control damper properties with independent response performance and independent robustness while using a machine learning algorithm.

In order to solve the aforementioned problems, one aspect of the present invention provides a damper control system comprising: one or more processors; and a memory storing instructions which, when the instructions are executed by the one or more processors, cause the damper control system to function as: a damper control unit configured to control a property of a damper used in a suspension of a vehicle, and a processing unit configured to accept feedback data pertaining to behavior of the vehicle measured in the vehicle, apply computational processing specified by executing a machine learning algorithm to the feedback data, and output a control variable obtained from the computational processing to the damper control unit, wherein the damper control unit controls the property of the damper on the basis of a control variable used internally within the damper control unit, and replaces the control variable used internally with a new control variable, the new control variable being the control variable output by the processing unit.

Another aspect of the present invention provides, a vehicle comprising: a damper used in a suspension; one or more processors; and a memory storing instructions which, when the instructions are executed by the one or more processors, cause the vehicle to function as: a damper control unit configured to control a property of the damper; and a processing unit configured to accept feedback data pertaining to behavior of the vehicle measured in the vehicle, apply computational processing specified by executing a machine learning algorithm to the feedback data, and output a control variable obtained from the computational processing to the damper control unit, wherein the damper control unit controls the property of the damper on the basis of a control variable used internally within the damper control unit, and replaces the control variable used internally with a new control variable, the new control variable being the control variable output by the processing unit.

Still another aspect of the present invention provides, an information processing apparatus that is used along with a damper controller which controls a property of a damper used in a suspension of a vehicle, the information processing apparatus comprising: one or more processors; and a memory storing instructions which, when the instructions are executed by the one or more processors, cause the information processing apparatus to function as: a processing unit configured to accept feedback data pertaining to behavior of the vehicle measured in the vehicle, apply computational processing specified by executing a machine learning algorithm to the feedback data, and output a control variable obtained from the computational processing to the damper control unit, wherein the damper control unit controls the property of the damper on the basis of a control variable used internally within the damper control unit, and replaces the control variable used internally with a new control variable, the new control variable being the control variable output by the processing unit.

Yet another aspect of the present invention provides, a method of controlling a damper control system, the system including a damper controller which controls a property of a damper used in a suspension of a vehicle and one or more processors, and the method comprising: carrying out processing of accepting feedback data pertaining to behavior of the vehicle measured in the vehicle, applying computational processing specified by executing a machine learning algorithm to the feedback data, and outputting a control variable obtained from the computational processing to the damper controller; and controlling the property of the damper on the basis of a control variable used internally within the damper controller, the control variable used internally having been replaced with a new control variable, the new control variable being the control variable which has been output in the outputting.

Still yet another aspect of the present invention provides, a method of controlling a vehicle, the vehicle including a damper used in a suspension, a damper controller configured to control a property of the damper, and one or more processors, and the method comprising: carrying out processing of accepting feedback data pertaining to behavior of the vehicle measured in the vehicle, applying computational processing specified by executing a machine learning algorithm to the feedback data, and outputting a control variable obtained from the computational processing to the damper controller: and controlling the property of the damper on the basis of a control variable used internally within the damper controller, the control variable used internally having been replaced with a new control variable, the new control variable being the control variable which has been output in the outputting.

Yet still another aspect of the present invention provides, a method of controlling an information processing apparatus that is used along with a damper controller configured to control a property of a damper used in a suspension of a vehicle, the method comprising: carrying out processing of accepting feedback data pertaining to behavior of the vehicle measured in the vehicle, applying computational processing specified by executing a machine learning algorithm to the feedback data, and outputting a control variable obtained from the computational processing to the damper controller, wherein the damper controller controls the property of the damper on the basis of a control variable used internally within the damper controller, and replaces the control variable used internally with a new control variable, the new control variable being the control variable output in the outputting.

Still yet another aspect of the present invention provides, a non-transitory computer-readable storage medium storing a program for causing a computer to function as each unit of a damper control system, the damper control system comprising: a damper control unit configured to control a property of a damper used in a suspension of a vehicle; and a processing unit configured to accept feedback data pertaining to behavior of the vehicle measured in the vehicle, apply computational processing specified by executing a machine learning algorithm to the feedback data, and output a control variable obtained from the computational processing to the damper control unit, wherein the damper control unit controls the property of the damper on the basis of a control variable used internally within the damper control unit, and replaces the control variable used internally with a new control variable, the new control variable being the control variable output by the processing unit.

According to the present invention, it is possible to control damper properties with independent response performance and independent robustness while using a machine learning algorithm.

### BRIEF DESCRIPTION OF THE DRAWINGS

FIG. 1 is a block diagram illustrating an example of the functional configuration of a vehicle and an information processing apparatus according to an embodiment of the present invention.

FIG. 2 is a diagram illustrating an overview of operations and a configuration pertaining thereto, for a case where reinforcement learning is used, as an example of damper control according to the embodiment.

FIG. 3 is a diagram illustrating a configuration for a case where an actor-critic method is applied, as an example of damper control according to the embodiment.

FIG. 4 is a flowchart illustrating a series of operations in damper control according to the embodiment.

FIG. 5 is a diagram illustrating an example of sensors which can be used in the embodiment, and sensor data measured by those sensors.

### DESCRIPTION OF THE EMBODIMENTS

Hereinafter, embodiments will be described in detail with reference to the attached drawings. Note that the following embodiments are not intended to limit the scope of the claimed invention, and limitation is not made to an invention that requires all combinations of features described in the embodiments.

Two or more of the multiple features described in the embodiments may be combined as appropriate. Furthermore, the same reference numerals are given to the same or similar configurations, and redundant description thereof is omitted.

Configuration of Vehicle and Information Processing Apparatus

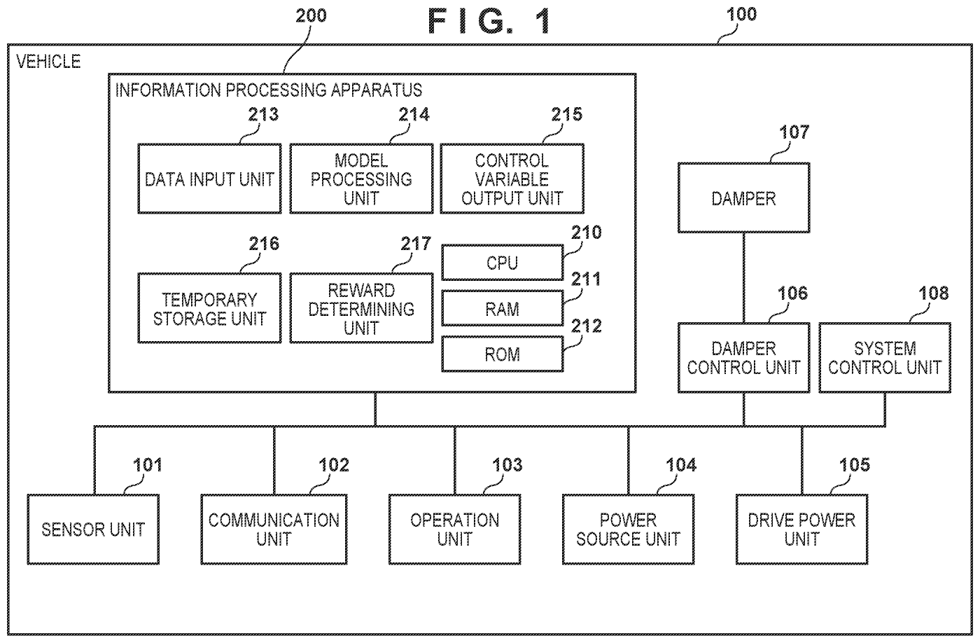

The configuration of a vehicle 100 and an information processing apparatus 200 according to the present embodiment will be described with reference to FIG. 1. A damper control system according to the present embodiment includes the information processing apparatus 200, a damper control unit 106, and dampers 107. Although the present embodiment will describe a case where the vehicle 100 is a four-wheeled vehicle provided with active dampers, the present embodiment may be applied in a two-wheeled vehicle, a work machine such as a snowplow vehicle, or the like, as long as the vehicle is capable of controlling behavior using active dampers. In the embodiment described hereinafter, the vehicle includes both a body and a damper, but situations simply indicating vertical-direction acceleration of the vehicle are assumed to refer to vertical-direction acceleration of the vehicle body.

Furthermore, the function blocks described hereinafter with reference to the drawings may be integrated or separated, and the functions described may be realized by other blocks instead. Functions described as being implemented by hardware may instead be implemented by software, or vice versa.

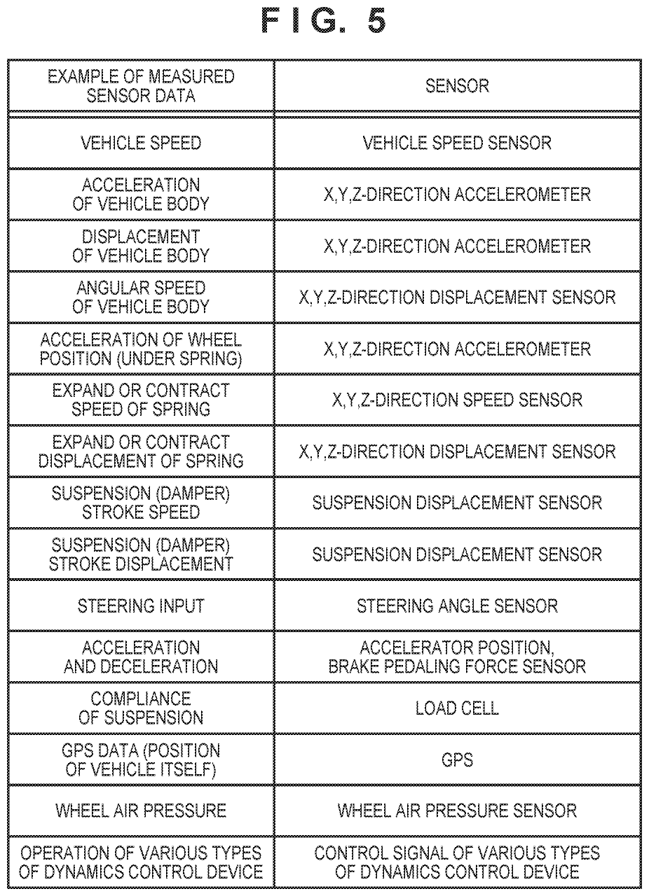

A sensor unit 101 includes various types of sensors provided in the vehicle 100, and outputs sensor data pertaining to the behavior of the vehicle 100. FIG. 5 illustrates an example of various types of sensors, in the sensor unit 101, which can be used in damper control processing according to the present embodiment, as well as the content measured by those sensors. The sensors include, for example, a vehicle speed sensor for measuring the speed of the vehicle 100; an accelerometer for measuring acceleration of the vehicle body; and a suspension displacement sensor which measures stroke behavior (speed, displacement, and so on) of the damper. A steering angle sensor which measures steering inputs, GPS which obtains the position of the vehicle itself, and so on are included as well. Note that in the following descriptions, data from these sensors which is used in damper control processing, and which pertains to the behavior of the vehicle 100 in particular, will be called “feedback data”. The feedback data pertaining to the vehicle 100, which has been output from the sensor unit 101, is input to the information processing apparatus 200, and is then input to a data input unit 213, a temporary storage unit 216, and a reward determining unit 217.

Additionally, the sensor unit 101 may include a camera. Lidar, and radar for recognizing conditions outside the vehicle, distances of objects to the vehicle, road surface states, and the like, as well as a sensor for recognizing the state of occupants in the vehicle.

A communication unit 102 is, for example, a communication device including communication circuitry and the like, and communicates with an external server, nearby traffic systems, and the like through standardized mobile communication such as LTE, LTE-Advanced, or what is known as 5G. Some or all of map data can be received from the external server, and traffic information and the like can be received from the traffic systems. The communication unit 102 can also send the various types of data obtained from the sensor unit 101 (sensor data or feedback data) to the external server. An operation unit 103 includes operation members such as buttons, a touch panel, and the like attached to the inside of the vehicle 100, as well as members for accepting inputs for driving the vehicle 100, such as a steering wheel and a brake pedal. A power source unit 104 includes a battery constituted by, for example, a lithium-ion battery, and supplies power to the various units in the vehicle 100. A drive power unit 105 includes, for example, an engine or a motor which produces drive power for causing the vehicle to travel.

The dampers 107 are used in the suspension of the vehicle 100, and are, for example, active dampers in which a damping force, which corresponds to damper properties, can be controlled. The control of the dampers 107 involves, for example, controlling the damping forces of the dampers 107 by controlling the amount of current flowing in coils within the dampers 107 so as to open internal valves and adjust pressure. The dampers 107 are constituted by four independent dampers 107, each of which can be controlled independently.

The damper control unit 106 is, for example, a software module for controlling the properties of the dampers 107, and the damper control unit 106 controls the damper properties (the properties of the four independent dampers 107) on the basis of a control variable output from the information processing apparatus 200. The damper control unit 106 will be described in detail later.

A system control unit 108 is a controller which controls the operations of the various units in the vehicle 100, and includes at least one processor. ROM, and RAM. Although the present embodiment will describe the system control unit 108 and the damper control unit 106 as being separate units, the damper control unit 106 may function as one part of the system control unit 108.

The information processing apparatus 200 obtains the feedback data from the sensor unit 101, and executes processing using a machine learning algorithm in damper control processing (described later). For example, the information processing apparatus 200 includes a CPU 210, RAM 211, ROM 212, the data input unit 213, a model processing unit 214, a control variable output unit 215, the temporary storage unit 216, and the reward determining unit 217.

The CPU 210 includes at least one processor, and controls the operations of the various units in the information processing apparatus 200 by loading computer programs stored in the ROM 212 into the RAM 211 and executing those programs. The RAM 211 includes DRAM or the like, for example, and functions as work memory for the CPU 210. The ROM 212 is constituted by a non-volatile storage medium, and stores computer programs executed by the CPU 210, setting values used when operating the information processing apparatus 200, and the like. In the following, the embodiment will describe a case where the CPU 210 executes the processing of the model processing unit 214, but the processing of the model processing unit 214 may be executed by one or more other processors (not shown; e.g., a GPU or the like).

The data input unit 213 obtains the feedback data stored in the temporary storage unit 216 (mentioned later), and carries out pre-processing on the data. Features of a driving state, driving inputs, and so on of the vehicle, input as feedback data, are subjected to various types of processing so as to be easily processed by the machine learning algorithm. One example of this processing includes converting feedback data in a predetermined period into maximum values, minimum values, or the like. Processing the feedback data in advance in this manner makes it possible to achieve greater efficiency in processing, learning, and so on than when the raw feedback data is handled directly by the machine learning algorithm.

The model processing unit 214 carries out computations for a machine learning algorithm such as reinforcement learning, for example, and outputs the obtained output to the control variable output unit 215. The model processing unit 214 executes the reinforcement learning algorithm using the feedback data from the data input unit 213 and reward data from the reward determining unit 217, and outputs a control variable to be provided to the damper control unit 106. By optimizing (i.e., learning) internal parameters through the execution of the reinforcement learning algorithm and then applying computational processing specified by the internal parameters to the feedback data, the model processing unit 214 outputs the optimal control variable based on the behavior of the vehicle 100.

The control variable output unit 215 outputs the control variable output from the model processing unit 214 to the damper control unit 106. The control variable output unit 215 may function as a control variable filtering unit which determines whether or not the control variable output from the model processing unit 214 is within a permissible range, and outputs the control variable to the damper control unit 106 only when it is determined that the control variable is within the predetermined permissible range. In this case, even if the model processing unit 214 has output a value that exceeds the permissible range, only an output which is within the permissible range is provided to the damper control unit 106.

The temporary storage unit 216 is constituted by a volatile or non-volatile storage medium, and temporarily stores the feedback data accepted by the information processing apparatus 200 from the sensor unit 101. The temporarily-stored feedback data is output to the data input unit 213 at a predetermined timing.

The reward determining unit 217 determines a reward or a penalty used by the machine learning algorithm (the reinforcement learning algorithm) on the basis of the feedback data, and outputs the reward or penalty to the model processing unit 214. The reward determining unit 217 will be described in detail later.

Overview of Damper Control Processing and Configuration of Related Blocks

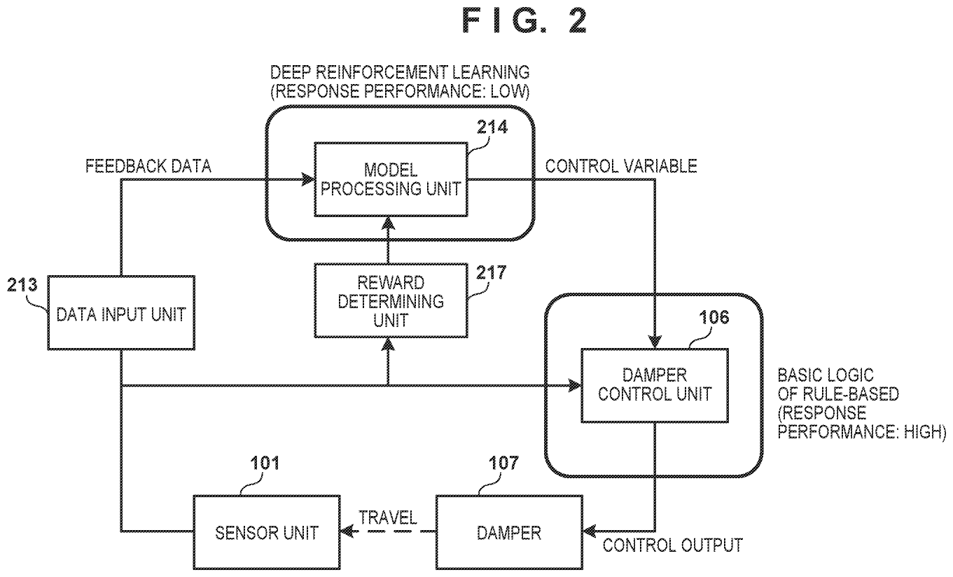

An overview of the damper control processing according to the present embodiment, and an example of the functional configuration used in the damper control processing, will be described next with reference to FIG. 2.

The damper control processing according to the present embodiment is implemented as hybrid processing constituted mainly by computational processing using the machine learning algorithm, carried out by the model processing unit 214, and rule-based computational processing carried out by the damper control unit 106.

With such a configuration, the damper control unit 106 can, using the rule-based computational processing, control the dampers with lower-order control outputs, at a high operating frequency of several hundreds of hertz. On the other hand, the model processing unit 214 can execute higher-order control at an operating frequency which is not as high as that of the damper control unit 106. The lower-order control by the damper control unit 106 is rule-based, which makes it easy for the operations of the damper control unit 106 to stabilize, and the operations can be understood. This makes it possible to ameliorate the low predictability of outputs obtained from deep reinforcement learning.

At a given time t, the model processing unit 214 accepts the feedback data, and outputs the control variable which has been obtained (from computational processing specified by executing the machine learning algorithm) to the damper control unit 106. In the reinforcement learning, the feedback data in this case corresponds to a state (sₜ) of the environment, and the control variable corresponds to an action (aₜ) made with respect to the environment.

Upon accepting the control variable from the model processing unit 214, the damper control unit 106 replaces a control variable used internally by the damper control unit 106 with the new control variable obtained from the model processing unit 214. The control variable includes, for example, a lookup table referenced by the rule-based processing of the damper control unit 106, parameters used by the damper control unit 106 to determine the damper properties, such as gain parameters based on the feedback data, and so on. The control variable is also a parameter through which the damper control unit 106 determines the damping force of the dampers 107 on the basis of the Skyhook theory. For example, the damping forces of the dampers 107 are controlled so that a body acceleration of the vehicle, which is measured by the sensor unit 101 of the vehicle 100, is aligned with an acceleration based on the Skyhook theory.

On the basis of the new control variable, the damper control unit 106 controls the damper properties with respect to the feedback data. At this time, the damper control unit 106 calculates a control amount for controlling the properties of the dampers 107. For example, the properties of the dampers 107 are the damping forces, and the control amount for controlling the properties of the dampers 107 is an amount of current that controls the damping forces. The damper control unit 106 repeats the damper control with respect to the feedback data, based on the new control variable, until the time reaches t+1.

The sensor unit 101 obtains and outputs the feedback data at time t+1 (the feedback data from time t to time t+1 may be collectively taken as the feedback data from time t+1). In the reinforcement learning, this feedback data corresponds to a state (sₜ₊₁) of the environment. The reward determining unit 217 determines a reward (rₜ₊₁) (or penalty) for the reinforcement learning on the basis of the feedback data from the sensor unit 101, and provides that reward (or penalty) to the model processing unit 214. In the present embodiment, the reward is a reward value pertaining to vehicle behavior, obtained from a predetermined combination of feedback data. The reward value may be the average or sum of reward values found from a plurality of viewpoints.

Upon accepting the reward (rₜ₊₁), the model processing unit 214 updates a policy and a state value function (described later), and outputs a new control variable with respect to the feedback data from time t+1 (action (aₜ₊₁)).

Configuration of Model Processing Unit 214

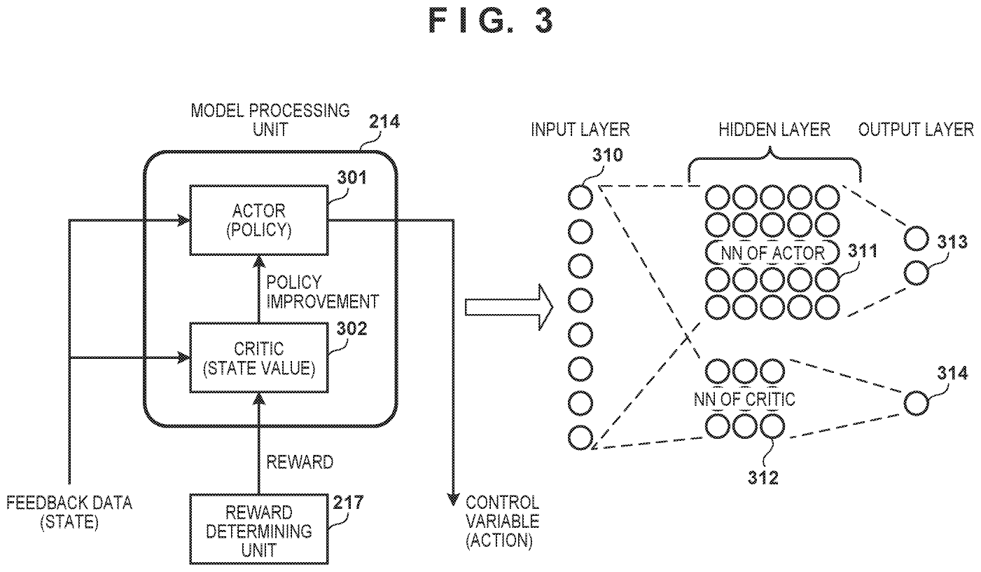

With reference to FIG. 3, the configuration of the model processing unit 214 will be described in more detail, and an example of the operations of the model processing unit 214 in the damper control processing will be described as well. FIG. 3 schematically illustrates an example of the internal configuration of the model processing unit 214 when an actor-critic method is used, and an example of a network configuration when the internal configuration of the model processing unit 214 is realized by a neural network (NN).

The model processing unit 214 includes an actor 301 and a critic 302. The actor 301 is a mechanism which selects an action (a) on the basis of a policy π(s,a). As one example, when the probability that the action a will be selected in a state s is represented by p(s,a), the policy is defined by np(s,a) and a predetermined function using, for example, a softmax function. The critic 302 is a mechanism that evaluates the policy π(s,a) currently being used by the actor and has a state value function V(s) expressing that evaluation.

Using the operations from time t to time t+1 described in FIG. 2 as an example, at a given time t, the actor 301 accepts the feedback data, and the control variable (i.e., the action (at)) is output on the basis of the policy π(s,a).

After damper control has been carried out by the damper control unit 106, once the feedback data from time t+1 (i.e., the state (sₜ₊₁)) is obtained, the reward (rₜ₊₁) based on that feedback data is input to the critic 302 from the reward determining unit 217.

The critic 302 calculates a policy improvement for improving the policy of the actor, and inputs the policy improvement to the actor 301. While the policy improvement may be found through a known predetermined calculation method, for example, known TD error δₜ=rₜ₊₁+γV(sₜ₊₁)−V(sₜ) (where γ is a discount reward in reinforcement learning), obtained using the reward and the feedback data, can be used as the policy improvement.

The actor 301 updates the policy π(s,a) on the basis of the policy improvement. The policy update can be carried out by, for example, replacing p(sₜ,aₜ) with p(sₜ,aₜ)+βδₜ (where β is a step size parameter). In other words, the actor 301 updates the policy using a policy improvement based on the reward. The critic 302 updates the state value function V(s) by replacing that function with V(s)+αδₜ (where α is a step size parameter).

The right side of FIG. 3 schematically illustrates an example of a network configuration when the internal configuration of the model processing unit 214 is realized by a neural network (NN). In this example, two neural networks are provided, one for the actor, and one for the critic. An input layer 310 is constituted by, for example, 1450 nodes (neurons). Signals input to the input layer are, for example, 29 ch×50 step (=1450) feedback data.

The signals input from the input layer 310 are transferred to a hidden layer 311 of the actor and a hidden layer 312 of the critic, and output values are obtained from respective output layers 313 and 314. The output from the NN of the actor is the policy, and the output from the NN of the critic is the state evaluation. As one example, the hidden layer 311 of the actor has a network structure including five layers of 500 nodes each, and the hidden layer 312 of the critic has a network structure including three layers of 300 nodes each. Additionally, the output layer 313 of the actor is constituted by, for example, 22 nodes, and the output layer 314 of the critic is constituted by, for example, a single node. However, the number of nodes and number of layers in the network, the network configuration, and so on can be changed as appropriate, and another configuration may be used.

To optimize a neural network, it is necessary to change weighting parameters of the neural network. The weighting parameters of a neural network are changed through back propagation using a predetermined loss function. There are two networks, i.e., the actor and the critic, in the present embodiment, and thus an actor loss function L_{actor} and a critic loss function L_{critic} are prepared in advance. The weighting parameters of the respective networks are changed by using, for example, a predetermined gradient descent optimization method for each loss function (e.g., RMSprop SGD).

Sequence of Operations in Damper Control Processing According to Present Embodiment

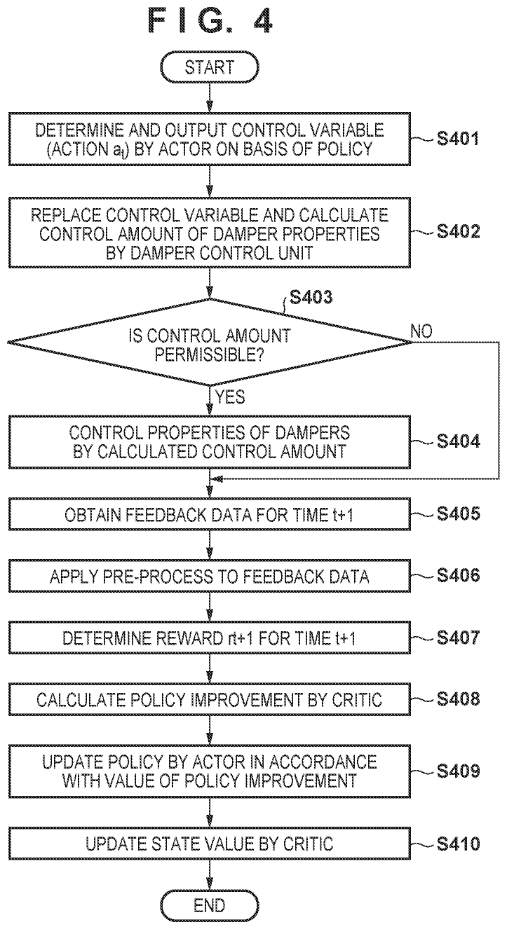

Next, a sequence of operations in the damper control processing according to the present embodiment will be described with reference to FIG. 4. Note that this processing is started upon the feedback data from time t being obtained, as described with reference to FIG. 2. Note also that the operations of the model processing unit 214 are assumed to be carried out at an operating frequency of 5 Hz, for example.

In step S401, the actor 301 accepts the feedback data from the data input unit 213, and outputs a control variable (i.e., the action (aₜ)) on the basis of the policy π(s,a).

In step S402, upon accepting the control variable from the model processing unit 214, the damper control unit 106 replaces the control variable used internally by the damper control unit 106 with the new control variable obtained from the model processing unit 214. The damper control unit 106 then controls the properties of the damper 107 by applying the replaced control variable to the feedback data. Note that in the flowchart illustrated in FIG. 4, steps S402 to S404 are illustrated as a single instance of control by the damper control unit 106, for the sake of simplicity. However, for feedback data which can be obtained at a speed of 1 KHz, for example, the damper control unit 106 controls the damper properties at an operating frequency of 100 Hz, for example, and controls the control amount (the amount of current for controlling the damping force of the dampers 107) at that operating frequency. Accordingly, the processing from steps S402 to S404 can actually be repeated until time t+1.

In step S403, the damper control unit 106 determines whether or not the calculated control amount (e.g., the amount of current) is within a predetermined permissible range. If the control amount is permissible, the sequence moves to step S404, and if the control amount is not permissible, the sequence moves to step S405. Although the present embodiment describes the damper properties as not being changed when the control amount is not permissible, other control may be carried out instead. For example, a control amount determined to not be permissible may be corrected to a predetermined upper limit value which is permissible, and the dampers 107 may then be controlled using the corrected control amount. By making such a determination, even if the control amount found on the basis of the control variable from the model processing unit 214 is an abnormal value, that control value can be excluded as appropriate or corrected to an appropriate value. This makes it possible to realize more stable damper control.

In step S404, the damper control unit 106 controls the properties of the dampers 107 by supplying the calculated control amount (e.g., the amount of current) to the dampers.

In step S405, the sensor unit 101 obtains the feedback data from up until time t+1 (e.g., at an operating frequency of 1 KHz).

In step S406, the data input unit 213 subjects the feedback data to the processing described earlier to apply the pre-processing. Although not illustrated in the flowchart of FIG. 4, the data input unit 213 may determine whether or not the input feedback data is data which exceeds the predetermined permissible range. If the data is determined to exceed the permissible range (i.e., is an abnormal value for the sensor data), the sequence may end so that processing is not carried out using that feedback data. Doing so makes it possible to update the internal parameters of the model processing unit 214 (e.g., update the policy, the state evaluation, and so on) within a permissible feedback data range.

In step S407, the reward determining unit 217 determines the aforementioned reward (rₜ₊₁) on the basis of the feedback data from time t+1, and outputs that reward to the critic 302. In step S408, the critic 302 calculates the aforementioned policy improvement (e.g., TD error) for improving the policy of the actor, and inputs the policy improvement to the actor 301.

In step S409, the actor 301 updates the policy π(s,a) on the basis of the policy improvement from step S407. The actor 301 then updates the policy by, for example, replacing p(sₜ, aₜ) with p(sₜ,aₜ)+βδₜ through the above-described method. In step S410, the critic 302 updates the state value function V(s) by replacing that function through the above-described method, e.g., with V(s)+αδₜ (where α is a step size parameter). The sequence ends after the critic 302 updates the state value function. Although the present embodiment describes the operations from time t to time t+1 as an example, the series of operations illustrated in FIG. 4 may be repeated, with the sequence of processing ending when a predetermined condition is satisfied.

As described thus far, according to the present embodiment, the damper properties are controlled using the damper control unit 106, which controls the damper properties, and the model processing unit 214, which applies feedback data to computational processing specified by executing a machine learning algorithm and outputs a control variable for controlling the damper control unit 106. By doing so, the damper properties can be controlled with independent response performance and independent robustness wile using a machine learning algorithm.

Variations

The foregoing embodiment described an example in which the damper control unit 106 executes predetermined rule-based computational processing. However, a simple network configuration, e.g., a neural network that takes the control variable as part of the input, where the network weighting is fixed after learning and the operations are fully verified in advance, may be used for the computations by the damper control unit 106 instead of rule-based computational processing. In other words, if such a neural network is used, stable processing results can be obtained through operations at high speeds such as those provided by rule-based computational processing.

Additionally, the foregoing embodiment described the feedback data as being temporarily stored in the temporary storage unit 216, with that feedback data then being read out by the data input unit 213. By doing so, in the reinforcement learning of the embodiment, the internal parameters are updated through online learning, which enables learning which quickly responds to changes in the environment at that time. However, the learning can be stabilized even more by sending the feedback data stored in the temporary storage unit 216 to an external server and then carrying out batch processing in the external server. With learning carried out using batch processing, the internal parameters updated through the batch processing may be received from the external server.

Furthermore, the foregoing embodiment described a case where the information processing apparatus 200 is installed within the vehicle 100 as an example. However, the information processing apparatus 200 may be installed outside the vehicle (e.g., in an external server), and the feedback data and control variables may then be exchanged between the vehicle 100 and the external server. The embodiment described above can operate effectively even if the information processing apparatus 200 and the damper control unit 106 are provided remotely with respect to each other in this manner. In other words, the damper control unit 106 can be controlled with a higher-order output through the machine learning algorithm, while also ensuring that the damper control unit 106 has high response performance.

### SUMMARY OF EMBODIMENTS

1. A damper control system (e.g., 106, 107, 200) according to the foregoing embodiment includes: a damper control unit (e.g., 106) configured to control a property of a damper (e.g., 107) used in a suspension of a vehicle (e.g., 100): and a processing unit (e.g., 213, 214, 215) configured to accept feedback data pertaining to behavior of the vehicle measured in the vehicle, apply computational processing specified by executing a machine learning algorithm to the feedback data, and output a control variable obtained from the computational processing to the damper control unit. The damper control unit controls the property of the damper on the basis of a control variable used internally within the damper control unit, and replaces the control variable used internally with a new control variable, the new control variable being the control variable output by the processing unit.

According to this embodiment, it is possible to provide a damper control system which can control damper properties with independent response performance and independent robustness while using a machine learning algorithm.

2. In the damper control system according to the above-described embodiment, the damper control unit controls the property of the damper at a first operating frequency, and the processing unit outputs the control variable to the damper control unit at a second operating frequency which is lower than the first operating frequency.

According to this embodiment, the damper control unit can control the property of the damper more quickly than the processing unit.

3. In the damper control system according to the above-described embodiment, the control of the property of the damper on the basis of the control variable used internally is carried out by the damper control unit through predetermined rule-based computational processing (e.g., 106) which is not computational processing specified by executing a machine learning algorithm.

According to this embodiment, lower-order control by the damper control unit is rule-based, which makes it easy for the operations of the damper control unit to stabilize, and the operations can be understood.

4. In the damper control system according to the above-described embodiment, the damper control unit controls the property of the damper in accordance with a determination that a control amount of the property of the damper is within a permissible range, the control amount having been obtained on the basis of the new control variable obtained from the replacement (e.g., steps S403, S404).

According to this embodiment, even if the control amount found on the basis of the control variable from the model processing unit 214 is an abnormal value, that control value can be excluded as appropriate or corrected to an appropriate value, which makes it possible to realize more stable damper control.

5. The damper control system according to the above-described embodiment further includes a control variable filtering unit (e.g., 215) configured to determine whether the control variable output from the processing unit is within a permissible range, and input the control variable output from the processing unit into the damper control unit only in a case where the control variable has been determined to be within the permissible range.

According to this embodiment, even if the output of the processing unit is a value that exceeds the permissible range, only an output which is within the permissible range is provided to the damper control unit.

6. The damper control system according to the above-described embodiment further includes: a feedback data filtering unit (e.g., 213, step S406) configured to determine whether the feedback data is within a permissible range, and input the feedback data into the processing unit only in a case where the feedback data has been determined to be within the permissible range.

According to this embodiment, the internal parameters of the processing unit can be updated (in the case of deep reinforcement learning, the policy, the state evaluation, and so on, for example, can be updated) within a permissible feedback data range.

7. In the damper control system according to the above-described embodiment, the processing unit further accepts a reward or a penalty calculated on the basis of feedback data pertaining to behavior of the vehicle, and applies the computational processing to the feedback data (e.g., 214, 217).

According to this embodiment, an algorithm that updates the internal parameters of the processing unit using a reward or a penalty based on the feedback data can be applied.

8. In the damper control system according to the above-described embodiment, the machine learning algorithm includes a deep reinforcement learning algorithm (e.g., FIG. 3).

According to this embodiment, a higher-order control variable can be output adaptively in accordance with the circumstances.

9. In the damper control system according to the above-described embodiment, the feedback data includes data pertaining to measurement data pertaining to behavior of a body of the vehicle, measurement data pertaining to stroke behavior of the damper, and measurement data pertaining to a steering angle of the vehicle.

According to this embodiment, damper control which takes into account the overall situation can be carried out using higher-order feedback data.

10. In the damper control system according to the above-described embodiment, the property of the damper is a damping force of the damper.

According to this embodiment, the damper control processing according to the above-described embodiment can be applied to control of the damping force of an active damper.

11. In the damper control system according to the above-described embodiment, the control variable output from the processing unit is a control variable for determining the damping force of the damper on the basis of the Skyhook theory.

According to this embodiment, the damper control processing according to the above-described embodiment can control the damper using the Skyhook theory.

12. A vehicle according to the above-described embodiment includes: a damper used in a suspension; a damper control unit configured to control a property of the damper; and a processing unit configured to accept feedback data pertaining to behavior of the vehicle measured in the vehicle, apply computational processing specified by executing a machine learning algorithm to the feedback data, and output a control variable obtained from the computational processing to the damper control unit. The damper control unit controls the property of the damper on the basis of a control variable used internally within the damper control unit, and replaces the control variable used internally with a new control variable, the new control variable being the control variable output by the processing unit.

According to this embodiment, it is possible to provide a vehicle which can control damper properties with independent response performance and independent robustness while using a machine learning algorithm.

13. An information processing apparatus according to the above-described embodiment is an information processing apparatus that is used along with a damper control unit which controls a property of a damper used in a suspension of a vehicle. The apparatus includes a processing unit configured to accept feedback data pertaining to behavior of the vehicle measured in the vehicle, apply computational processing specified by executing a machine learning algorithm to the feedback data, and output a control variable obtained from the computational processing to the damper control unit. The damper control unit controls the property of the damper on the basis of a control variable used internally within the damper control unit, and replaces the control variable used internally with a new control variable, the new control variable being the control variable output by the processing unit.

According to this embodiment, an information processing apparatus is provided which can control damper properties with independent response performance and independent robustness while using a machine learning algorithm.

14. A program according to the above-described embodiment is a program for causing a computer to function as each unit of a damper control system. The damper control system includes: a damper control unit configured to control a property of a damper used in a suspension of a vehicle; and a processing unit configured to accept feedback data pertaining to behavior of the vehicle measured in the vehicle, apply computational processing specified by executing a machine learning algorithm to the feedback data, and output a control variable obtained from the computational processing to the damper control unit. The damper control unit controls the property of the damper on the basis of a control variable used internally within the damper control unit, and replaces the control variable used internally with a new control variable, the new control variable being the control variable output by the processing unit.

According to this embodiment, a program is provided which can control damper properties with independent response performance and independent robustness while using a machine learning algorithm.

The invention is not limited to the foregoing embodiments, and various variations/changes are possible within the spirit of the invention.

What is claimed is:

1. A damper control system comprising:
one or more processors; and
a memory storing instructions which, when the instructions are executed by the one or more processors, cause the damper control system to function as:
a damper control unit configured to control a property of a damper used in a suspension of a vehicle; and
a processing unit configured to accept feedback data pertaining to behavior of the vehicle measured in the vehicle, apply computational processing specified by executing a machine learning algorithm to the feedback data, and output a control variable obtained from the computational processing to the damper control unit,
wherein the damper control unit controls the property of the damper on the basis of a control variable used internally within the damper control unit, and replaces the control variable used internally with a new control variable, the new control variable being the control variable output by the processing unit.

2. The damper control system according to claim 1,
wherein the damper control unit controls the property of the damper at a first operating frequency, and the processing unit outputs the control variable to the damper control unit at a second operating frequency which is lower than the first operating frequency.

3. The damper control system according to claim 1,
wherein the control of the property of the damper on the basis of the control variable used internally is carried out by the damper control unit through predetermined rule-based computational processing which is not computational processing specified by executing a machine learning algorithm.

4. The damper control system according to claim 1,
wherein the damper control unit controls the property of the damper in accordance with a determination that a control amount of the property of the damper is within a permissible range, the control amount having been obtained on the basis of the new control variable obtained from the replacement.

5. The damper control system according to claim 1, wherein the instructions further cause the damper control system to function as:
a control variable filtering unit configured to determine whether the control variable output from the processing unit is within a permissible range, and input the control variable output from the processing unit into the damper control unit only in a case where the control variable has been determined to be within the permissible range.

6. The damper control system according to claim 1, wherein the instructions further cause the damper control system to function as:
a feedback data filtering unit configured to determine whether the feedback data is within a permissible range, and input the feedback data into the processing unit only in a case where the feedback data has been determined to be within the permissible range.

7. The damper control system according to claim 1,
wherein the processing unit further accepts a reward or a penalty calculated on the basis of feedback data pertaining to behavior of the vehicle, and applies the computational processing to the feedback data using the reward or the penalty.

8. The damper control system according to claim 7,
wherein the machine learning algorithm includes a deep reinforcement learning algorithm.

9. The damper control system according to claim 1,
wherein the feedback data includes data pertaining to measurement data pertaining to behavior of a body of the vehicle, measurement data pertaining to stroke behavior of the damper, and measurement data pertaining to a steering angle of the vehicle.

10. The damper control system according to claim 1,
wherein the property of the damper is a damping force of the damper.

11. The damper control system according to claim 10,
wherein the control variable output from the processing unit is a control variable for determining the damping force of the damper on the basis of the Skyhook theory.

12. A vehicle comprising:
a damper used in a suspension;
one or more processors, and
a memory storing instructions which, when the instructions are executed by the one or more processors, cause the vehicle to function as:
a damper control unit configured to control a property of the damper; and
a processing unit configured to accept feedback data pertaining to behavior of the vehicle measured in the vehicle, apply computational processing specified by executing a machine learning algorithm to the feedback data, and output a control variable obtained from the computational processing to the damper control unit,
wherein the damper control unit controls the property of the damper on the basis of a control variable used internally within the damper control unit, and replaces the control variable used internally with a new control variable, the new control variable being the control variable output by the processing unit.

13. An information processing apparatus that is used along with a damper controller which controls a property of a damper used in a suspension of a vehicle, the information processing apparatus comprising:
one or more processors; and
a memory storing instructions which, when the instructions are executed by the one or more processors, cause the information processing apparatus to function as:
a processing unit configured to accept feedback data pertaining to behavior of the vehicle measured in the vehicle, apply computational processing specified by executing a machine learning algorithm to the feedback data, and output a control variable obtained from the computational processing to the damper control unit,
wherein the damper control unit controls the property of the damper on the basis of a control variable used internally within the damper control unit, and replaces the control variable used internally with a new control variable, the new control variable being the control variable output by the processing unit.

14. A method of controlling a damper control system, the system including a damper controller which controls a property of a damper used in a suspension of a vehicle and one or more processors, and the method comprising:
carrying out processing of accepting feedback data pertaining to behavior of the vehicle measured in the vehicle, applying computational processing specified by executing a machine learning algorithm to the feedback data, and outputting a control variable obtained from the computational processing to the damper controller; and
controlling the property of the damper on the basis of a control variable used internally within the damper controller, the control variable used internally having been replaced with a new control variable, the new control variable being the control variable which has been output in the outputting.

15. A method of controlling a vehicle, the vehicle including a damper used in a suspension, a damper controller configured to control a property of the damper, and one or more processors, and the method comprising:
carrying out processing of accepting feedback data pertaining to behavior of the vehicle measured in the vehicle, applying computational processing specified by executing a machine learning algorithm to the feedback data, and outputting a control variable obtained from the computational processing to the damper controller; and
controlling the property of the damper on the basis of a control variable used internally within the damper controller, the control variable used internally having been replaced with a new control variable, the new control variable being the control variable which has been output in the outputting.

16. A method of controlling an information processing apparatus that is used along with a damper controller configured to control a property of a damper used in a suspension of a vehicle, the method comprising:
carrying out processing of accepting feedback data pertaining to behavior of the vehicle measured in the vehicle, applying computational processing specified by executing a machine learning algorithm to the feedback data, and outputting a control variable obtained from the computational processing to the damper controller,
wherein the damper controller controls the property of the damper on the basis of a control variable used internally within the damper controller, and replaces the control variable used internally with a new control variable, the new control variable being the control variable output in the outputting.

17. A non-transitory computer-readable storage medium storing a program for causing a computer to function as each unit of a damper control system, the damper control system comprising:
a damper control unit configured to control a property of a damper used in a suspension of a vehicle; and
a processing unit configured to accept feedback data pertaining to behavior of the vehicle measured in the vehicle, apply computational processing specified by executing a machine learning algorithm to the feedback data, and output a control variable obtained from the computational processing to the damper control unit,
wherein the damper control unit controls the property of the damper on the basis of a control variable used internally within the damper control unit, and replaces the control variable used internally with a new control variable, the new control variable being the control variable output by the processing unit.
